(19) United States
(12) Patent Application Publication
(10) Pub. No.: US 2022/0041401 A1
(43) Pub. Date: Feb. 10, 2022

(54) CABLE REEL

(71) Applicant: RIJATEK Design Pty Ltd, Wasleys (AU)

(72) Inventors: John PACKER, Evanston (AU); Ian HAMPEL, Evanston (AU)

(73) Assignee: RIJATEK Design Pty Ltd, Wasleys (AU)

(21) Appl. No.: 17/443,922

(22) Filed: Jul. 28, 2021

(30) Foreign Application Priority Data
Aug. 6, 2020 (AU) 2020902768

(51) Int. Cl. B65H 75/28

(52) U.S. Cl. CPC B65H 75/28

(57) ABSTRACT

There is proposed a cable reel, comprising mirrored first and second side portions forming an outwardly open cable receiving annular chamber therebetween for holding a cable. The cable reel includes a tapered neck wherein the cable is configured to pass though the tapered neck during winding up and dispensing of the cable, whereby jamming of the cable within the annular chamber is inhibited. The cable reel further includes a passageway for receiving a first plug attached to a first end of the cable therethrough, at least two apertures for utilisation by a user to facilitate rotation of the cable, and a plurality of plug holding members for retaining a second plug attached at a second end of the cable.

### FIELD OF THE INVENTION

The present invention relates generally to a reel for a length of cable and in one aspect relates to a reel for audio-type cables.

### BACKGROUND OF THE INVENTION

Reels are used in various applications to retain a cable, hose, rope or other flexible elongate member in a coiled arrangement. Common situations in which such audio-type cables are used are at live music events and by individuals for their instruments and amplification equipment. Often live music events are held at a temporary facility or a stage configuration is tailored for the specific event. Accordingly, there are often numerous lengths of cables that must be run for the instruments, sound equipment and other audio/visual equipment.

These cables are transported to the location and unrolled during setup and then rerolled either onto a reel or simply coiled by hand, during pack down. It is important that the lengths of cable are properly housed to prevent uncoiling which may result in tangling of the cables. Since the setup and pack down are typically under a tight time constraint, such tangles pose a significant problem.

There are various reels that have been developed to house cables which assist in the storage, deployment and use. One such storage unit is disclosed in U.S. Pat. No. 6,186,433 (Kovacik et al.) which teaches a spool rotatably connected to a frame, whereby upon rotation of the spool a cable is wound onto or dispensed from the unit. The device of Kovacik could be understood to be of a similar configuration of a garden hose reel. One of the limitations with such a device is that the cable can get jammed when dispensing, if it has not been evenly stacked on the spool during winding up.

Another document that discloses a cable reel, is UK Patent Application No. 2438394 (Watt) that describes a manually operated cable storage device. The device of Watt includes a central hub and a rotatably mounted disc, wherein the operator squeezes the centre hub, thereby stopping the disc from rotating while the cable/lead is wound onto the device. When removing the cable, the operator holds the centre hub, which allows the disc to rotate off the centre hub as the cable is dispensed. Watt also discloses a clip or slit for retaining an end of the cable, however the cable may still get jammed when dispensing the cable if it has been unevenly stacked during winding.

US Patent Application No. 2019/0062100 (Mertesdorf) discloses a central feed for a cable storage device, however the device is used for telecommunication cables and the like that can feed through the apparatus, rather than being wound onto and off a reel.

Another document that discloses a cable storage spool is U.S. Pat. No. 6,625,374 (Holman), for storage of excess lengths of cables. The device of Holman how includes a relatively complex system of retaining a central portion of the cable around centre posts so that the spool can be wound in either direction to capture the cable within a storage chamber. In many situations, including live band settings the cables must be removed from the reel which would not be practical with the device of Holman.

The phrase ‘neck’ used throughout the specification should be understood to relate to a narrow portion that allows entry of a cable and inhibits unrolling or jamming of the coiled cabled. It should be appreciated that although the invention will be described with particular reference to audio cables, the invention may also be used in relation to any type of cable, hose or other flexible elongate member.

It should be appreciated that any discussion of the prior art throughout the specification is included solely for the purpose of providing a context for the present invention and should in no way be considered as an admission that such prior art was widely known or formed part of the common general knowledge in the field as it existed before the priority date of the application.

### SUMMARY OF THE INVENTION

It is an object of the illustrated invention to provide a portable apparatus for coiling cable or the like thereonto. Other objects of the illustrated embodiments are to overcome at least some of the aforementioned problems, or at least provide the public with a useful alternative. The foregoing objects should not necessarily be considered as cumulative and various aspects of the invention may fulfil one or more of the above objects.

The present invention could be broadly understood to comprise a reel for a length of flexible cable/rope/hose, comprising opposing sides forming a circumferential outwardly open chamber, an opening for receiving an end of the cable/rope/hose, and a tapered neck for directing and controlling the movement of the cable/rope/hose as it is being wound onto or dispensed from, the reel.

In one aspect of the invention, but not necessarily the broadest or only aspect there is proposed cable reel, comprising a first side portion being detachably couplable to a second side portion to form an outwardly open annular chamber for receiving a cable therein; a tapered neck formed between the coupled first side portion and the second side portion adjacent said annular chamber, wherein the cable being configured to pass though the tapered neck during winding up and dispensing of thereof, whereby jamming of the cable within the annular chamber is inhibited; a passageway intersecting the tapered neck being configured for receiving a first plug attached to a first end of the cable therethrough; at least two apertures through the first and/or second side portions, configured for utilisation by a user to facilitate rotation of the cable reel for retrieval and/or dispensing of the cable; and a number of plug holding members spaced apart around or adjacent the circumference of the cable reel for retaining a second plug attached at a second end of said cable.

The passageway is formed between the first and second side portions and intersecting the tapered neck, wherein the first plug is insertable through the passageway and positionable within a central plug holding void, whereafter the cable being wound onto the cable reel, such that the cable is substantially located within the annular chamber.

Preferably, the central plug holding void includes at least one location for retaining the first plug. In a preferred form the central plug holding void includes a window or windows through which the end of the cable can be viewed by a user from an exterior of the cable reel. In this way the user can identify the configuration of the first plug.

In one form the first plug can be accessed through the window, wherein in use, it is not necessary to completely remove the cable from the cable reel and the reel could be left connected to the cable to assist in the speed of pack down.

The plug holding members may be a slit or coaxially aligned slits or recesses that extending into or through one or both the first and second side portions. The slits or recesses may extend generally perpendicular to the tapered neck.

The first and second plugs may be selected from a group including, but not limited to, minijacks, audio jacks (mono/stereo), XLR, RCA, BNC, ST, DVI connector, HDMI, TOSLINK, or any other type of connector.

The first and second side portions preferably include coaxially alignable aperture. Preferably, each first and second side portions include a centrally positioned first aperture and a second and third apertures positioned to sides therefore. Once assembled these apertures provide a user with finger engaging portions, wherein the user can insert a digit from one hand in through the coaxially aligned first aperture from one side of the reel. The user can then insert a digit from their other hand in through the second and third apertures from the opposite side of the reel and rotate the reel to wind up the cable.

The first, second and third apertures are preferably generally circular and curved to inhibit injury the hand of the user.

In another form, a handle or rod may be used to engage the first and/or second/third apertures, wherein the handle or rod can be held by the use to assist in the winding or unwinding of the cable from the cable reel.

The first and second side portions are preferably connected by way of cooperating curved wall parts that extend inwardly from each of the first and second side portions. These curved wall parts form an edge of the central plug holding void and include retaining clips for coupling the first and second side portions together.

In one form the curved wall parts are generally crescent shaped and extend between a position adjacent the second aperture and a position adjacent the third aperture. When assembled the first plug at the end of the cable can be inserted through a gap between the sides of the second and third apertures into the central plug holding void that extending around the sides of the first aperture.

The passageway for receiving the plug at the first end of the cable aligns with the gap between the sides of the second and third apertures.

The passageway for receiving the plug at the first end of the cable therethrough may be formed by a depression in sides of the generally circumferentially extending tapered neck formed between the first and second side portions. This provides an enlarged aperture through which the plug is able to pass.

In one form the passageway is dimensioned to frictionally engage sides of the plug, wherein the user is able to force the first plug through into the central plug holding void.

The plug holding members spaced apart around or adjacent the circumference of the reel are configured to frictionally engage the second plug once the cable has been wound onto the cable reel, whereby the second plug can be easily located and grasped by a user when the cable needs to be unwound from the cable reel. Another advantage is that the user can identify the configuration of the plug at the second end of the cable without having to partially unwind the cable.

The reader will appreciate that the configuration of the reel enables the storage of a cable and the easy identification of plugs at both ends of the cable.

Preferably, the outer face of each of the first and second side portions have three or more respective protrusions extending outwardly therefrom to provide a docking location for stacking several side portions or assembled reels together and for creating support feet to inhibit outer surface scuffing.

In preference the first and second side portions can be disconnected and reversed, such that they can be positioned in a stackable or nested arrangement.

In one form the first and second side portions are identical in shape and configuration and are able to be positioned in a mirrored arrangement whereby they can be connected together using cooperating clip portions. This also means that any two side portions can be coupled together without having to locate a left and right position.

The cable receiving annular chamber includes a generally open V-shaped base, parallel sides and an inwardly tapered upper part leading to, or forming a part of the tapered neck.

The tapered neck forms a narrowed gap between the first and second side portions and is positioned generally at a centre line of the reel. In this way, the narrowed gap though which the cable is feed causes the coiled cable to tend to stack in a triangular configuration, which thereby inhibits jamming of the cable against sides of the annular chamber.

It is preferable that the cable storage area has an exit angle greater than that formed by the generally triangular shape of the stacked cable. In one form the exit angle of the annular chamber is between 45° and 65°, and preferably 54°. Accordingly, the exit angle is dependent upon the diameter of the cable being stored therein and the exit angle may thereby be modified during manufacture to suit different sized cables.

The outwardly open portion of the neck includes oppositely facing circumferential lips having a part at an angle of between 5° and 40°, and preferably 10.1°. This therefore guides the cable into the annular chamber to form a generally triangular stacked arrangement. It should however be appreciated that other geometry of the reel could be used without departing from the scope of the invention.

In still another aspect of the invention there is proposed a method of coiling a cable onto a cable reel in accordance with any of the above aspects, including the steps of: inserting the first plug attached to the first end of the cable in through the passageway, wherein the first plug is positioned within the central plug holding void; rotating the reel using the at least two apertures; and sliding the second plug attached to the second end of the cable into frictional engagement with one of the plug holding members that are spaced apart around or adjacent the circumference of the reel, wherein the cable is held in a coiled arrangement within the cable reel.

### BRIEF DESCRIPTION OF THE DRAWINGS

The accompanying drawings, which are incorporated in and constitute a part of this specification, illustrate an implementation of the invention and, together with the description and claims, serve to explain the advantages and principles of the invention. In the drawings,

FIG. 1 is a perspective view of the reel of the present invention, illustrating the insertion of a first end of a cable in through the passageway;

FIG. 2 is a perspective view of the reel of FIG. 1, retaining the coiled cable;

FIG. 3 is an exploded view of the reel of FIG. 1, illustrating the coiled cable and interconnectable body portions of the reel;

FIG. 4 is an exploded view of the reel of FIG. 3, illustrating the position of the coiled cable relative to one of the body portions;

FIG. 5 is an end view of the reel of FIG. 1 illustrating the plug opening and tapered neck;

FIG. 6 is a perspective view of an inner side of one of the body portions;

FIG. 7 is a side view of the body portion of FIG. 6;

FIG. 8 is a perspective view of an outer side of the body portion of FIG. 6;

FIG. 9 is a side view of the body portion of FIG. 8;

FIG. 10 is a cross-sectional view through A-A of FIG. 1, illustrating the tapered neck;

FIG. 11 is a cross-sectional view through B-B of FIG. 2, illustrating the stacking of the cable within the cable chamber;

FIG. 12 is a perspective view of FIG. 11, further illustrating the stacking of the cable within the cable chamber;

FIG. 13 is a partial view of FIG. 11, illustrating the geometry of the tapered neck and cable receiving annular chamber;

FIG. 14 is a side view of the disassembled body portions of FIG. 1 being stacked; and

FIG. 15 is a cross-selection view of the stacked body portions of FIG. 14.

### DETAILED DESCRIPTION

Similar reference characters indicate corresponding parts throughout the drawings. Dimensions of certain parts shown in the drawings may have been modified and/or exaggerated for the purposes of clarity or illustration.

Referring to the drawings for a more detailed description, there is illustrated a cable reel 10, demonstrating by way of an example, an arrangement in which the principles of the present invention may be employed.

The figures illustrate one embodiment of the cable reel 10 for storing a cable 12 comprising, a first side portion 14, and a second side portion 16, which are detachably connectable. A cable receiving annular chamber 18 is formed between the first and second side portions 14, 16, as best illustrated in FIGS. 5, and 10-12. A tapered neck 20 is formed between the first and second side portions 14, 16 for assisting in controlling the movement of the cable 12 as it is feed into and dispended from the annular chamber 18, while inhibiting jamming of the cable 12 against edges 22 thereof.

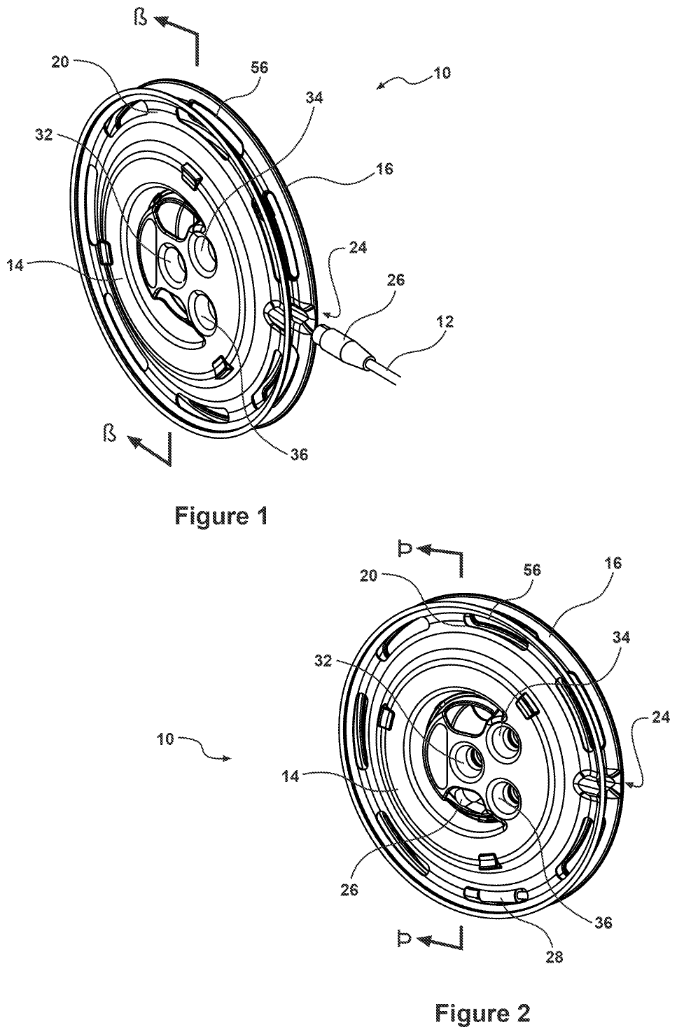

As illustrated in FIG. 1, the reel 10 includes a passageway 24 for receiving a first end of the cable 12, with first plug 26, which intersects the tapered neck 20. The reader will appreciate that respective plugs 26, 28 are attached to oppose ends of the cable 12. The plug 26 therefore attached to a first end of the cable 12, can be inserted in through the passageway 24 into a central plug holding void 30, as illustrated in FIGS. 2, 4 and 12. The cable 12 can then be wound onto the cable reel 10, and the plug 28 at the other end of the cable 12, can be attached to the plug holding members 56 spaced apart around or adjacent the circumference of the cable reel 10, to retain the coiled cable 12 within the annular chamber 18.

The cable reel 10 further includes apertures 32, 34, 36, in or through the first and/or second side portions 14, 16, wherein a user can utilise the apertures 32, 34 and/or 36 to rotate the cable reel 10 to retrieve and/or dispense the cable 12.

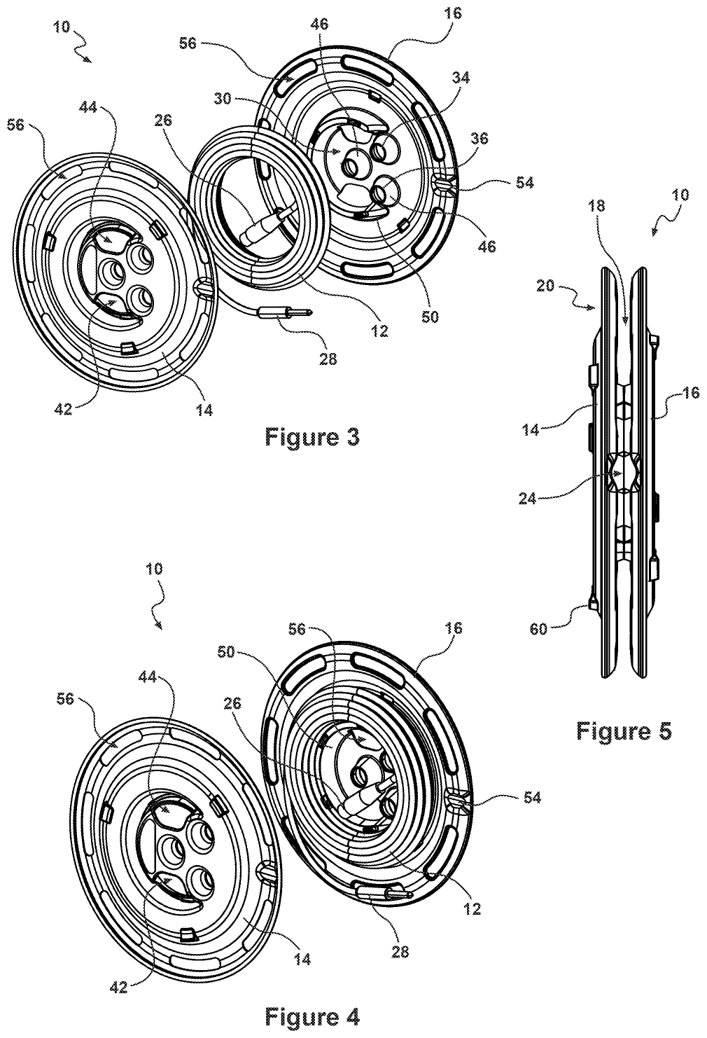

As illustrated in FIGS. 3, 4, 10 and 11, the central plug holding void 30, includes two locations 38, 40 in which the first plug 26 can be positioned. Windows 42, 44 allow a user to view or access the plug 26 at the end of the cable 12.

As illustrated in the figures the plug 26 is a XLR and the plug 28 is a jack, the reader will however appreciated that other types of plug or configurations of plug could be used.

The apertures 32, 34, 36 of side portion 14 are configured to coaxially align aperture 32, 34, 36 of side portion 16, when assembled, as illustrated in FIG. 2. Each of the respective apertures 32, 34, 36 include a frustoconical shaped wall 46. The aperture 32 is centrally positioned and the apertures 34, 36 are positioned to a side therefore. These apertures provide a user with finger engaging members, wherein the user can insert a digit from one hand in through the coaxially aligned apertures 32 from one side of the reel 10 and insert a digit from their other hand in through the apertures 34 or 36 from the opposite side of the reel 10. The user is then able to rotate the reel 10 to wind up the cable 10.

The reader should appreciate that the central aperture 32 allows for the placement of a digit/finger to act as the centre of rotation, and the two other similar shaped apertures 34, 36, positioned off centre are used to rotate/crank the reel 10 with another digit/finger to wind the cable 12 into the reel 10. Although other components are not required, a rod, shaft or handle could also be used in place of the one or both of the digits/fingers.

The first and second side portions 14, 16 are connected by way of bayonet hooks 48 located on a curved wall part 50 of the first or second side portion 14, 16, which are configured to engage with slots 52 in the curved wall part 50 of the opposing side portion 14 or 16.

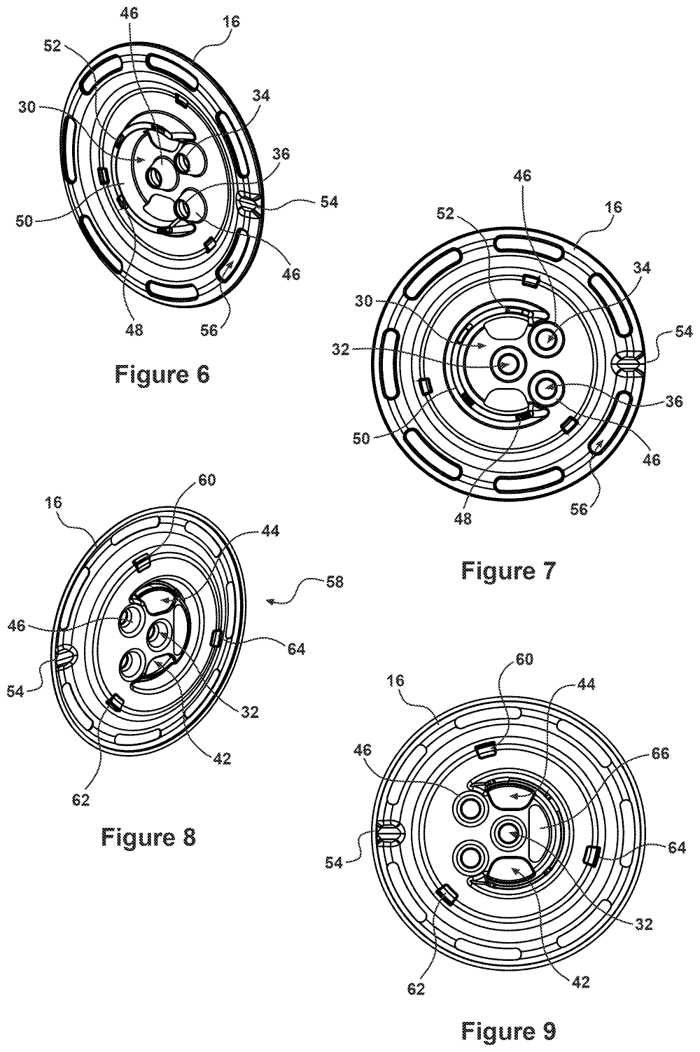

The reader will appreciate that in a preferred form the first side portion 14 is identical to the second wall portion 16, wherein when one is reversed it is able to engage an opposing mirrored side portion. Accordingly, the curved wall part 50 includes two bayonet hooks 48 and two slots 52, as illustrated in FIGS. 6 and 7. The curved wall part 50 extend inwardly from each of the first and second side portions to abut with the wall part 50 of the opposing side portion, to thereby form the cable receiving annular chamber 18 and central plug holding void 30.

The configuration of the bayonet hooks 48 and two slots 52 ensures that the edges of the passageway 24 align when assembled.

The curved wall parts 50 and the frustoconical shaped walls 46 of aperture 32, 34, 36 of the opposing sides 14, 16 form the edges of the central plug holding void 30.

The passageway 24 for receiving the first end of the cable 12 therethrough may be formed by depressions 54 in sides of the generally circumferentially extending tapered neck 20, as shown in FIG. 5. This provides an enlarged aperture through which the first plug 26 is able to pass.

The reader will appreciate that although the tapered neck 20 generally extending circumferentially around the cable reel 10, but may be a series of sections that are positioned intermediate of plug holding members 56 in the form of spaced apart slits, which extend through both the first and second side portions 14, 16, and align, as best illustrated in FIG. 2. These slits 56 provide multiple locations in which the second plug 28 may be held around the circumference of the cable reel 10, which means that the configuration of the plug 28 can also be easily seen. The slits 56 may also provide areas of less frictional engagement with the cable 12 as it passes through. Furthermore, the slits 56 can be used as handles to grasp the device 10 or may be used to secure a cable tie therethrough to further inhibit unravelling or prevent unauthorised access, such as when on display for sale of the product.

As illustrated in FIGS. 8 and 9, the outer face 58 of each of the second side portions 16, has three protrusions 60, 62, 64 extending outwardly therefrom. The reader will appreciate that this is also the case for the first side portion 14. The protrusions 60, 62, 64 provide a docking location when stacking several side portions or assembled reels together, and for creating support feet to inhibit outer surface scuffing when the cable reel 10 is placed on the ground during use.

The outer surface 58 may also include a depression 66 for receiving a label (not shown) to identify the configuration of the cable or ownership of the cable and reel.

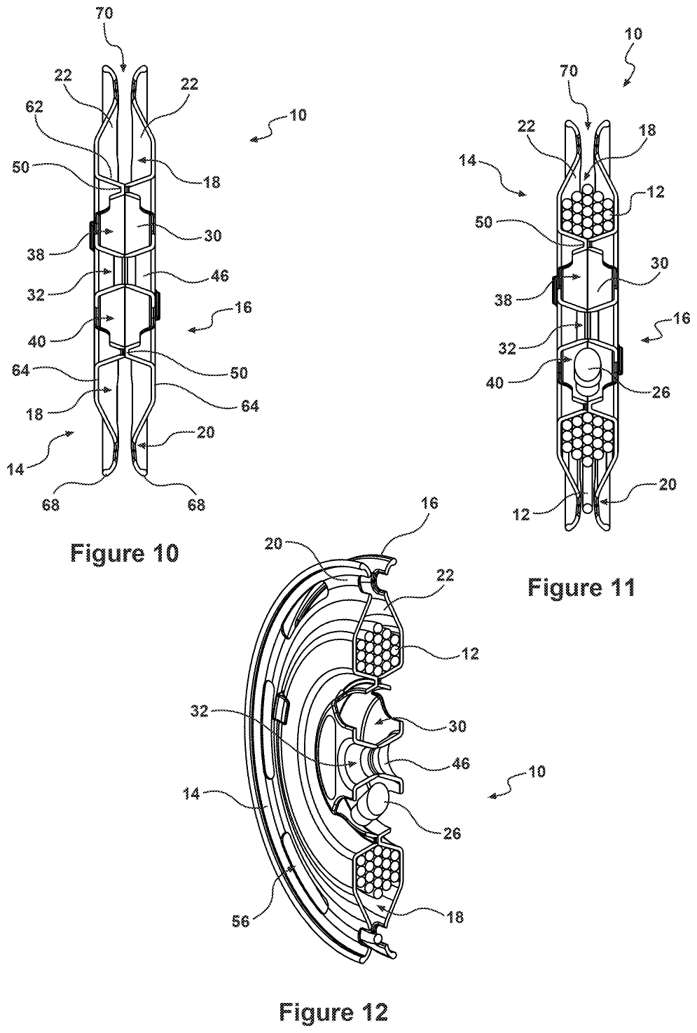

FIG. 10 illustrates one embodiment of the outwardly open cable receiving annular chamber 18 that has a wide, open V-shaped base 62, parallel sides 64 and an inwardly tapered upper parts 22 leading to, or forming the neck 20. As illustrated in FIG. 10, the central plug holding void 30 is formed around the frustoconical shaped wall 46 of aperture 32 and the extent is defined generally by the curved wall parts 50. The reader will appreciate that the central plug holding void 30 is also delineated by at least a part or parts of the frustoconical shaped wall 46 of apertures 34, 36.

The outwardly open portion of the neck 20 includes oppositely facing circumferential lips 68, which form a cable receiving opening. The outer rim therefore forms a funnelled cable inlet opening 70, and the series of plug clasping slits 56 allow for the secure storage of the plug 28 at multiple positions around the circumference of the cable reel 10.

FIGS. 11 and 12 illustrate the cable 12 positioned within the cable receiving annular chamber 18. It has been found that having the narrowed gap 70 generally at the centre line of the reel 10 means that the cable tends to stack in a generally triangular configuration. However, at times, such as when a long length of cable is rolled onto the reel whereby the coiled cable is adjacent the inwardly tapered upper parts 22 or when an upper coil slides to one side, the cable 12 could potentially jam against the sides of the upper parts 22.

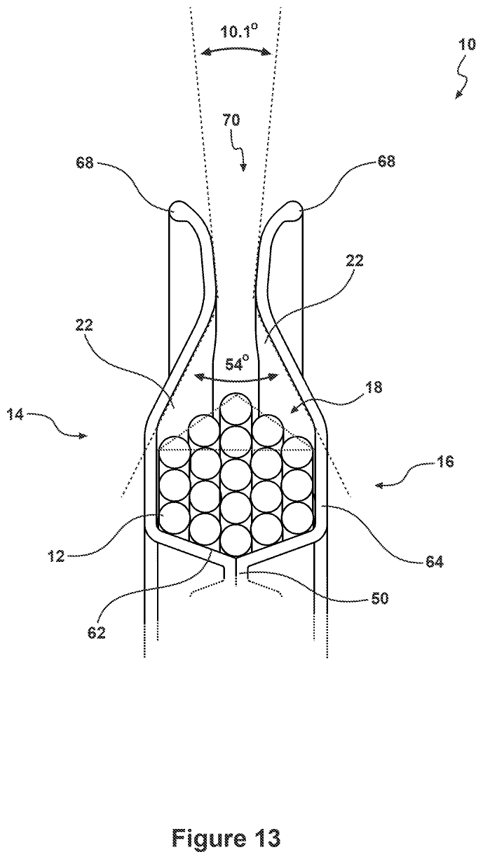

Accordingly, the angle of the upper parts 22 relative to each other is important in the operation of the reel 10. FIG. 13 illustrates what could be referred to as the exit angle of the annular chamber 18 which may be between 50° and 65°, and in the present embodiment is 54°. The cable storage area/annular chamber 18 is envisaged to have an exit angle greater than that of the triangle shape of the stacked cable (as shown in broken lines) which is formed by the stacking cable, to thereby inhibit jamming of the cable 12 against edges 22.

As further illustrated in FIG. 13 the narrowed gap 70 includes a part that has an angle of between 5° and 50°, and in the present embodiment is 10.1°, which assist with the winding up and dispending of the cable 12.

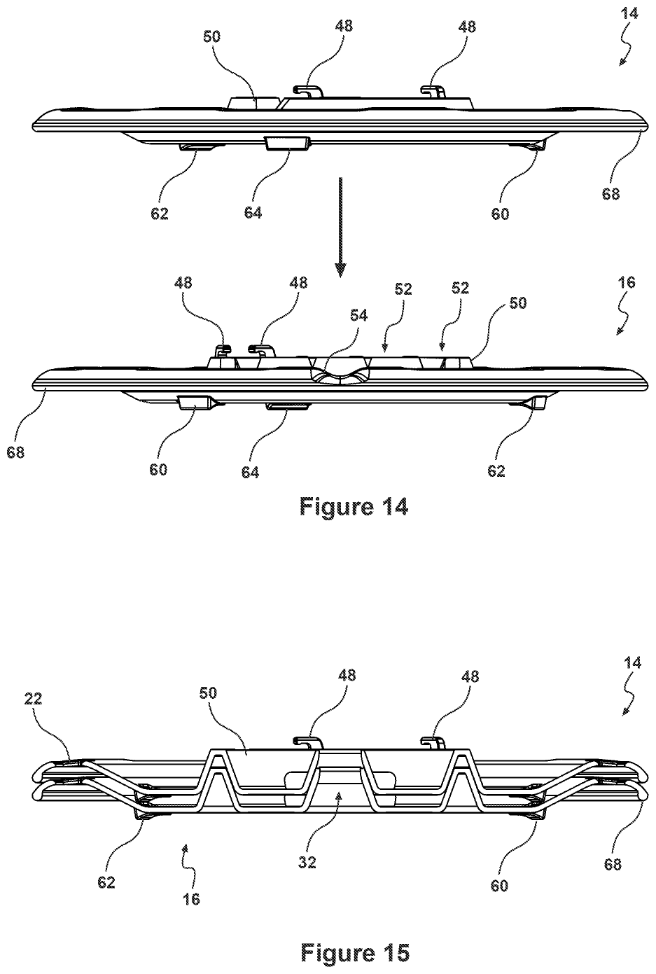

As illustrated in FIG. 14, the first and second side portions 14 and 16 can be disconnected, and one of the portions (in this case 14) can be reversed, such that the side portions can be positioned in a stacked or nested arrangement, as illustrated in FIG. 15. This stacked or nested arrangement means that the reel 10 takes up less room when it is being stored without cable wound onto it and may inhibit damage as the tapered portions are supported by protrusions 60, 62, 64 and the circumferential lips 68 of adjacent portions 14, 16 are in close proximity or may in fact touch.

In the present embodiment the first and second side portions 14, 16 are identical in shape and configuration which means that any two side portions can be coupled together without having to locate a left and right. Therefore, a stack of side portions can be provided and a user simply has to take any two portions and fit them together.

The configuration of the bayonet hooks 48, which are configured to engage slots 52 are further illustrated in FIGS. 14 and 15.

In use the user inserts the plug 26 connected to the cable 12 in though the passageway 24, as illustrated in FIG. 2. The reader will appreciate that the passageway 24 imparts a certain amount to friction and the user therefore forces the plug 26 through the passageway 24. The plug 26 is then further inserted between the sides 46 of apertures 34, 36 into the central plug holding void 30, as illustrated in FIG. 1. In this position the user can identify the configuration of the plug 26, through windows 42 or 44, which are positioned on either side of aperture 32.

The cable 12 is then manually wound onto the reel 10, such that it is held in a configuration as shown in FIG. 4. Finally, the plug 28 at the opposed end of the cable 12 is pushed into opposing slits 56, such that it is frictionally engaged therewith, as further illustrated in FIG. 1, wherein the type of the plug 28 can be easily seen by a user.

The skilled addressee will now appreciate the advantages of the illustrated invention over the prior art. In one form the illustrated embodiment provide cable reel for storage of a cable that inhibits jamming of the cable within the reel and enables easy identification of plugs at both ends of the cable. The present invention provides a means of storing cables, such as audio and video cables, that are valuable and require some care in storage to maximise their serviceable life. Since the cables can be damaged by twisting and being bent sharply, the transition area from cable length to plug body also suffers from these two detrimental effects, which are overcome with the configuration of the present invention.

Furthermore, the illustrated invention ensures that cables are generally twist free while being stored which means in use the cable tends to lay flat thereby reducing trip hazards. The reel may also provide protection from physical and UV damage, while presents the cable plugs for easy identification and selection.

Various features of the invention have been particularly shown and described in connection with the exemplified embodiments of the invention, however it must be understood that these particular arrangements merely illustrate the invention and it is not limited thereto. Accordingly, the invention can include various modifications, which fall within the spirit and scope of the invention.

1. A cable reel, comprising:
a first side portion being detachably couplable to a second side portion to form an outwardly open annular chamber for receiving a cable therein;
a tapered neck formed between the coupled first side portion and the second side portion adjacent said annular chamber, wherein the cable being configured to pass though the tapered neck during winding up and dispensing of thereof, whereby jamming of the cable within the annular chamber is inhibited;
a passageway intersecting the tapered neck being configured for receiving a first plug attached to a first end of the cable therethrough;
at least two apertures through the first and/or second side portions, configured for utilisation by a user to facilitate rotation of the cable reel for retrieval and/or dispensing of the cable; and
a number of plug holding members spaced apart around or adjacent the circumference of the cable reel for retaining a second plug attached at a second end of said cable.

2. The cable reel in accordance with claim 1, wherein the first side portion and second side portion delineate a central plug holding void for retaining the first plug after it has been inserted through the passageway, whereafter the cable being wound onto the cable reel such that the cable is substantially located within the annular chamber.

3. The cable reel in accordance with claim 2, wherein the central plug holding void includes a window or windows through which the first plug is viewable or the first plug is accessible for use.

4. The cable reel in accordance with claim 1, wherein the plug holding members for retaining the second plug are coaxially aligned slits or recesses in the first side portion and second side portion.

5. The cable reel in accordance with claim 1, wherein each of the first side portion and second side portion include a coaxially alignable centrally positioned first aperture and coaxially alignable second and third apertures positioned to sides therefore, wherein a user can utilise the apertures for winding up and dispensing of the cable by rotation of the cable reel.

6. The cable reel in accordance with claim 1, wherein the first side portion and second side portion are connected by way of cooperating curved wall parts that extend inwardly from each of the first and second side portions, the curved wall parts forming an edge of the central plug holding void and include retaining clips for reversibly coupling the first side portion and second side portion together.

7. The cable reel in accordance with claim 1, wherein the passageway is dimensioned to frictionally engage sides of the plug, wherein the user is able to force the first plug through into the central plug holding void.

8. The cable reel in accordance with claim 1, wherein the plug holding members spaced apart around or adjacent the circumference of the reel are configured to frictionally engage the second plug once the cable has been wound onto the cable reel, whereby the second plug can be easily located and grasped by a user when the cable needs to be unwound from the cable reel.

9. The cable reel in accordance with claim 1, wherein the outer face of each of the first and second side portions have three or more respective protrusions extending outwardly therefrom.

10. The cable reel in accordance with claim 1, wherein the tapered neck forms a narrowed gap between the first and second side portions and is positioned generally at a centre line of the reel, whereby the narrowed gap though which the cable is feed causes the coiled cable to tend to stack in a generally triangular configuration, which thereby inhibits jamming of the cable against sides of the annular chamber.

11. The cable reel in accordance with claim 10, wherein the cable storage area has an exit angle greater than that formed by the generally triangular configuration of the stacked cable.

12. The cable reel in accordance with claim 10, wherein the exit angle of the annular chamber is between 45° and 65°.

13. A method of coiling a cable, including the steps of:
providing a cable reel in accordance with claim 2;
inserting the first plug attached to the first end of the cable in through the passageway, wherein the first plug is positioned within the central plug holding void; rotating the reel using the at least two apertures; and
sliding the second plug attached to the second end of the cable into frictional engagement with one of the plug holding members that are spaced apart around or adjacent the circumference of the reel, wherein the cable is held in a coiled arrangement within the cable reel.
